(19) United States
(12) Patent Application Publication
(10) Pub. No.: US 2025/0356200 A1
(43) Pub. Date: Nov. 20, 2025

(54) LEARNING METHOD, LEARNING DEVICE, STORAGE MEDIUM, AND LEARNING DATA GENERATION METHOD

(71) Applicant: DENSO TEN Limited, Kobe (JP)

(72) Inventor: Ryusuke SEKI, Kobe (JP)

(73) Assignee: DENSO TEN Limited, Kobe (JP)

(21) Appl. No.: 19/081,426

(22) Filed: Mar. 17, 2025

(30) Foreign Application Priority Data
May 15, 2024 (JP) 2024-079347

(51) Int. Cl. G06N 3/0895

(52) U.S. Cl. CPC G06N 3/0895

(57) ABSTRACT

A learning method for performing learning of a machine learning model using unlabeled data with no labels includes: inputting the unlabeled data to the machine learning model to generate pseudo labels; performing a first selection of selecting a pseudo label for learning from the generated pseudo labels based on reliability; performing a second selection of selecting, based on image sizes of objects to which the pseudo labels are given, the pseudo label for learning from pseudo labels that are discard targets that has not been selected as the pseudo label for learning in the first selection; and performing the learning using the pseudo label for learning.

### CROSS-REFERENCE TO RELATED APPLICATIONS

This application is based on and claims priority under 35 USC 119 from Japanese Patent Application No. 2024-079347 filed on May 15, 2024, the contents of which are incorporated herein by reference.

### TECHNICAL FIELD

The present disclosure relates to a technique of machine learning using unlabeled data.

### BACKGROUND

In supervised learning, it is necessary to attach a label of a ground truth to all data to be used for learning, and thus it takes a high cost to create a data set. In view of such a problem, in the related art, there is known a technique of associating a pseudo label with unlabeled, in order to generate a highly accurate detection model (AI model) from a small number of labeled data (for example, see International Publication No. WO2022/185899A).

In addition, in the related art, there is known a technique of generating a highly accurate AI model while reducing a creation cost of a data set by performing learning by combining a small number of labeled data and a large number of unlabeled data. Such a learning method is called semi-supervised learning.

In order to obtain a highly accurate AI model, a high-reliability pseudo label is used for learning at the time of executing machine learning.

However, when the pseudo label is simply selected according to the reliability, it is determined that a pseudo label of an object image having a small size has lower reliability than a pseudo label of an object image having a large size, and it is found that the pseudo label of the object image having a small size tends to be easily discarded. Specifically, not only a pseudo label but also both a pseudo label and an image (image data) corresponding to the pseudo label are used for learning. When a pseudo label is discarded by selecting a pseudo label as described above, an image corresponding to the pseudo label is also excluded from a learning target together with the pseudo label.

In the method in the related art, many pseudo labels of object images having a small size tend to be discarded and many pseudo labels of object images having a large size are likely to be kept at the time of selecting a pseudo label used for learning. In this case, there is a concern that an imbalance of the object size occurs in learning data, and the detection accuracy of the AI model obtained after the learning with respect to a small object image decreases.

In view of the above, the present disclosure relates providing a technique enabling to generate an AI model capable of accurately detecting an object regardless of an image size of the object.

### SUMMARY

An aspect of the present disclosure relates to a learning method for performing learning of a machine learning model using unlabeled data with no labels. The learning method includes: inputting the unlabeled data to the machine learning model to generate pseudo labels; performing a first selection of selecting a pseudo label for learning from the generated pseudo labels based on reliability; performing a second selection of selecting, based on image sizes of objects to which the pseudo labels are given, the pseudo label for learning from pseudo labels that are discard targets that has not been selected as the pseudo label for learning in the first selection; and performing the learning using the pseudo label for learning.

According to the exemplary aspect of the present disclosure, selection of the pseudo label to be used for learning is performed in consideration of not only the reliability of the pseudo label but also the size of the object image to which the pseudo label is given. Therefore, it is possible to make it less likely that many or most of discarded pseudo labels are pseudo labels of small object images at the time of selecting pseudo labels. As a result, it is possible to generate an AI model capable of accurately detecting an object regardless of an image size of the object.

### BRIEF DESCRIPTION OF DRAWINGS

Exemplary embodiments of the present disclosure will be described in detail based on the following figures, in which:

FIG. 1 is a block diagram illustrating a hardware configuration of a learning device;

FIG. 2 is a block diagram illustrating an outline of functional units included in the learning device;

FIG. 3 is a schematic diagram illustrating a configuration of a mini-batch;

FIG. 4 is a block diagram illustrating a detailed functional configuration of a label selector;

FIG. 5 illustrates an outline of a first selection to be executed by a first selector;

FIG. 6 is a flowchart illustrating a flow of a learning method to be executed by the learning device;

FIG. 7 is a flowchart illustrating detailed processing of step S2 in FIG. 6;

FIG. 8 is a flowchart illustrating detailed processing of step S3 in FIG. 6;

FIG. 9 is a flowchart illustrating detailed processing of step S4 in FIG. 6;

FIG. 10 is a block diagram illustrating a detailed functional configuration of a label selector according to a first modification;

FIG. 11 is a flowchart illustrating processing using a student model of unlabeled data in a learning device according to the first modification; and

FIG. 12 is a flowchart illustrating a flow of a learning data generation method according to a second modification.

### DESCRIPTION OF EMBODIMENTS

Hereinafter, exemplary embodiments of the present invention will be described in detail with reference to the drawings.

### 1. LEARNING DEVICE

### 1-1. Outline

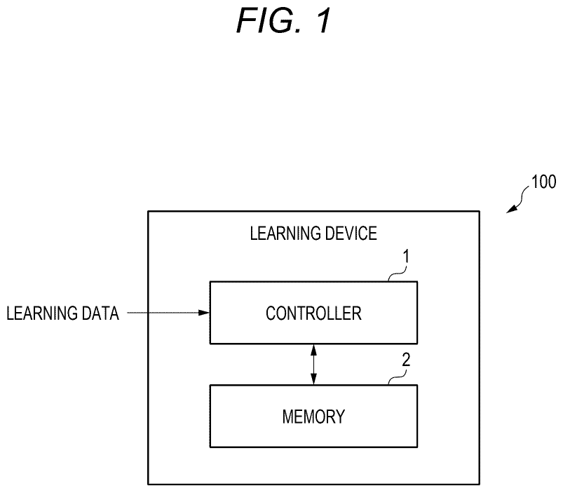

FIG. 1 is a block diagram illustrating a hardware configuration of a learning device 100 according to an embodiment of the present invention. The learning device 100 is a device that performs training of a machine learning model (AI model). In the present embodiment, the machine learning model is a neural network model, specifically, an object detection model that detects an object by inputting image data.

A data structure and a learning algorithm of the object detection model are not particularly limited. The algorithm of object detection in the object detection model may be, for example, R-CNN, Fast R-CNN, Faster R-CNN, YOLO, or SSD.

The object detection model learned (trained) by the learning device 100 (learned model) is mounted on, for example, a vehicle. As a detailed example, the object detection model is applied to an in-vehicle periphery monitoring device that monitors a situation of periphery of a vehicle. The in-vehicle periphery monitoring device processes, by the object detection model, an image of the periphery of the vehicle input from an in-vehicle camera, and detects an automobile, a two-wheeled vehicle, a person, a traffic light, a guide sign, and the like present in the periphery of the vehicle.

The learning device 100 is a computer device and includes a controller 1 and a memory 2 as illustrated in FIG. 1. The learning device 100 may include an input device such as a keyboard and an output device such as a display.

The controller 1 includes an arithmetic circuit that performs arithmetic processing. Specifically, the controller 1 includes a processor that performs arithmetic processing and the like. The processor includes, for example, a central processing unit (CPU) and a graphics processing unit (GPU). The controller 1 may be implemented by one processor or may be implemented by a plurality of processors. When the controller 1 is implemented by a plurality of processors, these processors may be communicably connected to one another.

The memory 2 includes a volatile memory and a nonvolatile memory. The volatile memory may include, for example, a random access memory (RAM). The nonvolatile memory may include, for example, a read only memory (ROM), a flash memory, or a hard disk drive. The nonvolatile memory stores a computer-readable program and data. In the present embodiment, the memory 2 stores a structure and a parameter of the machine learning model and a code instruction for executing the machine learning model.

The program stored in the memory 2 is a computer program that causes a computer to implement functions of the controller 1. Such a computer program may be provided by, for example, a computer-readable nonvolatile recording medium. The nonvolatile recording medium may be, for example, an optical recording medium (for example, optical disk), a magneto-optical recording medium (for example, magneto-optical disk), a USB memory, or an SD card, in addition to the above-described nonvolatile memory. As another example, the computer program may be provided from a program providing server via a communication line such as the Internet (provided by so-called download).

The learning device 100 is a device that performs learning of a machine learning model using unlabeled data having no labels. The learning method to be performed by the learning device 100 is a learning method for performing learning of a machine learning model using the unlabeled data having no labels. A program that causes the learning device 100 to execute the learning method corresponds to a learning program.

Specifically, the learning device 100 performs training of the machine learning model by so-called semi-supervised learning. The semi-supervised learning is a combination of supervised learning and unsupervised learning, and is one type of machine learning. In semi-supervised learning, learning is executed using both image data having labels (supervised image data) and image data having no labels (unsupervised image data). In semi-supervised learning, learning is usually executed using a large amount of unsupervised image data and a small amount of supervised image data. Hereinafter, unsupervised image data may be simply referred to as unlabeled data, and supervised image data may be simply referred to as labeled data.

The learning device 100 exhibits a function of learning a machine learning model by semi-supervised learning by a processor included in the controller 1 executing arithmetic processing according to a learning program stored in the memory 2. As illustrated in FIG. 1, the learning device 100 obtains learning data necessary for learning when learning the machine learning model. The learning device 100 executes learning of the machine learning model by semi-supervised learning using the obtained learning data.

The learning data may be provided by, for example, a computer-readable nonvolatile recording medium. As another example, the learning data may be provided from a learning data providing server via a communication line such as the Internet. The learning device 100 stores the obtained learning data in the memory 2 as appropriate.

### 1-2. Functional Unit of Learning Device

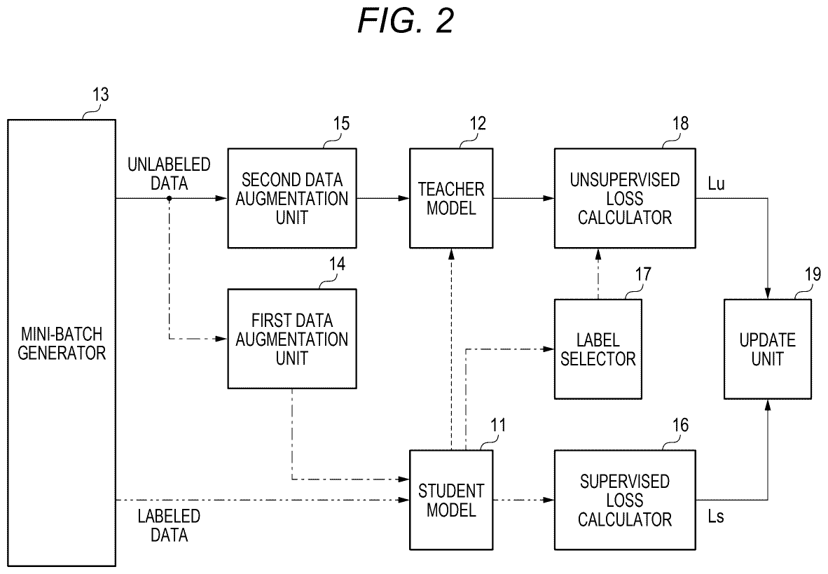

FIG. 2 is a block diagram illustrating an outline of functional units included in the learning device 100. The functional units illustrated in FIG. 2 are implemented by the processor included in the controller 1 executing arithmetic processing according to the learning program 20 stored in the memory 2. The functional units included in the learning device 100 include a student model 11, a teacher model 12, a mini-batch generation unit 13, a first data augmentation unit 14, a second data augmentation unit 15, a supervised loss calculator 16, a label selector 17, an unsupervised loss calculator 18, and an update unit 19.

The student model 11 is a machine learning model as a learning (training) target, specifically, an object detection model as a learning target. The student model 11 implemented as an object detection model executes an inference by receiving an image and detects an object in the image. When an object in the image is detected, the student model 11 specifies a type, a position, and a size of the object. The student model 11 is a learning target, and the object detection accuracy is low at least in an initial stage of learning. A structure and a parameter of 30 the student model 11 and a code instruction for executing the student model are stored in the memory 2. The student model 11 may have a configuration in which pre-learning is performed using a small amount of labeled data. However, the pre-learning is not essential.

The teacher model 12 is a machine learning model provided as means for implementing the semi-supervised learning. The teacher model 12 implemented as the object detection model executes an inference by receiving an image, and detects an object in the image. When an object in the image is detected, the teacher model 12 specifies a type, a position, and a size of the object and outputs the type, the position, and the size of the object as an inference result. The teacher model 12 is an example of a machine learning model different from the student model of the present invention. In the present embodiment, as a semi-supervised learning method, a method based on consistency is used in which it is expected that the output (inference result) of the model is the same even when images obtained by adding different perturbations to the same image are input. As used herein, the perturbation is data augmentation, dropout regularization, or the like. Regarding unlabeled data, the semi-supervised learning is implemented by obtaining a consistency loss of outputs of the student model 11 and the teacher model 12. That is, in the present embodiment, the teacher model 12 is learned so that such a consistency loss can be obtained.

Specifically, a weight (parameter) of the teacher model 12 is defined as an exponential moving average (EMA) of a weight of the student model 11. That is, a method of generating a target value by the teacher model 12 having an intermediate representation to obtain a consistency loss is adopted. A dashed arrow extending from the student model 11 to the teacher model 12 in FIG. 2 indicates that the teacher model 12 is defined by the EMA of the weight of the student model 11. A structure and a parameter of the teacher model 12 and a code instruction for executing the teacher model are stored in the memory 2. The present embodiment is a method using a so-called Mean Teacher, but instead of this, for example, Π-model, or Temporal Ensembling may be used.

The mini-batch generation unit 13 samples (extracts) data from unlabeled data and labeled data prepared in advance according to a predetermined condition to generate a mini-batch. Generation of the mini-batch enables mini-batch learning in which update of the parameter of the machine learning model as a learning target is performed not in units of one sample but in units of a small number of samples. The unlabeled data and the labeled data prepared in advance may be, for example, data already stored in the memory 2 or data input from the outside via a computer-readable nonvolatile recording medium or the like.

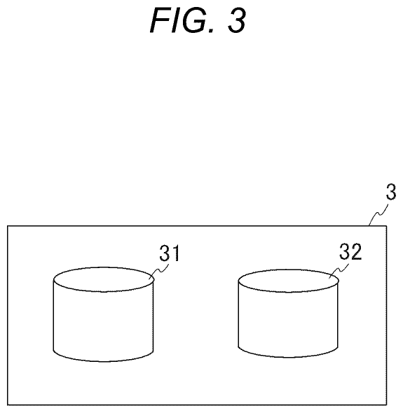

FIG. 3 is a schematic diagram illustrating a configuration of a mini-batch 3. As illustrated in FIG. 3, the mini-batch 3 includes an unlabeled data group 31, which is a collection of unlabeled data with no labels, and a labeled data group 32, which is a collection of labeled data having labels. The number of pieces of unlabeled data and the number of pieces of labeled data included in the mini-batch 3 are determined according to the above-described predetermined condition. The predetermined condition is determined such that the number of pieces of unlabeled data and the number of pieces of labeled data included in the mini-batch 3 have a constant ratio. The predetermined ratio may be, for example, 80% of the number of pieces of unlabeled data and 20% of the number of pieces of labeled data.

The mini-batch generation unit 13 may be provided in a device different from the learning device 100. That is, a mini-batch (collection of data) generated outside may be input to the learning device 100.

The first data augmentation unit 14 and the second data augmentation unit 15 (see FIG. 2) are provided as means for giving different perturbations to the same image as described above. Specifically, the first data augmentation unit 14 and the second data augmentation unit 15 execute data augmentation on the unlabeled data. The first data augmentation unit 14 is a data augmentation unit for the student model 11, and outputs data after the data augmentation to the student model 11. The second data augmentation unit 15 is a data augmentation unit for the teacher model 12, and outputs the data after the data augmentation to the teacher model 12. The first data augmentation unit 14 executes weaker data augmentation than the second data augmentation unit 15. Hereinafter, the data augmentation by the first data augmentation unit 14 may be referred to as weak data augmentation, and the data augmentation by the second data augmentation unit 15 may be referred to as strong data augmentation. A degree of change with respect to original data before the data augmentation is larger when the strong data augmentation is performed than when the weak data augmentation is performed.

The data augmentation is, for example, color tone transformation or affine transformation of image data. The color tone transformation may include, for example, color transformation, brightness transformation, contrast transformation, or at least two of these transformations. The affine transformation may include, for example, rotation, horizontal flip, enlargement, reduction, translation, or at least two of these transformations. The data augmentation may include both color tone transformation and affine transformation.

The supervised loss calculator 16 calculates a supervised loss Ls. The supervised loss Ls is a loss (error) between an inference result obtained by inputting labeled data with labels to the student model 11 and the labels. The supervised loss Ls may be obtained by a known method, and may be obtained by, for example, a mean square error or cross entropy.

The label selector 17 executes selection processing related to a pseudo label obtained as a result of the inference of the student model 11 with respect to the unlabeled data (specifically, data subjected to weak data augmentation). The pseudo label is a label temporarily attached to the unlabeled data according to the inference result of the student model 11 with respect to the unlabeled data. In the present embodiment, the pseudo label includes, as information, the type (class) of the detected object, the position in the image, and the image size. The position and the size of the object in the image are given by a bounding box. The number of pseudo labels obtained from one piece of unlabeled data may be singular or plural. In some cases, a pseudo label may not be obtained from one piece of unlabeled data.

In the pseudo labels obtained as the inference result of the student model 11, labels having high reliability and labels having low reliability are mixed. The label selector 17 selects a pseudo label having relatively high reliability from a plurality of pseudo labels in which labels having high reliability and labels having low reliability are mixed.

Specifically, the label selector 17 performs pseudo label selection processing in units of mini-batch. The mini-batch 3 includes a plurality of pieces of unlabeled data, and a plurality of pseudo labels are generated by inputting the plurality of pieces of unlabeled data to the student model 11. The label selector 17 executes selection processing for a plurality of pseudo labels obtained by the inference by the student model 11. The label selector 17 selects a pseudo label for learning to be used for learning from the plurality of pseudo labels based on reliability of the pseudo labels and sizes of object images to which the pseudo labels are given. Among the pseudo labels, a pseudo label that is not selected as the pseudo label for learning is excluded from the learning target together with image data corresponding to the pseudo label. The pseudo label for learning is regarded as a label and used for learning.

According to such a configuration, the selection of the pseudo label used for learning can be performed in consideration of not only the reliability of the pseudo label but also the image size of the object to which the pseudo label is given. That is, it is possible to make it less likely that many or most of discarded pseudo labels are pseudo labels of small object images at the time of selecting pseudo labels. As a result, it is possible to generate an object detection model (AI model) capable of accurately detecting an object regardless of the size of the object image.

In the present embodiment, the pseudo label for learning is selected, but a pseudo label that is not set as the pseudo label for learning may be selected as an exclusion (discard) target, and a remaining pseudo label that is not set as the exclusion target may be set as the pseudo label for learning.

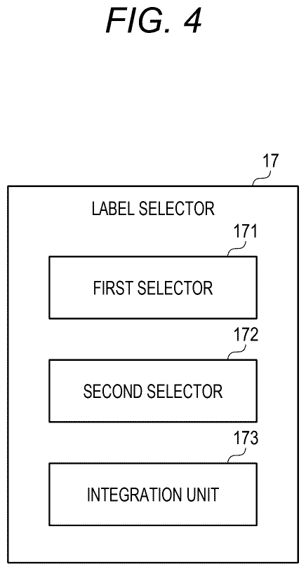

The selection processing of the label selector 17 will be described in more detail with reference to FIG. 4. FIG. 4 is a block diagram illustrating a detailed functional configuration of the label selector 17. As illustrated in FIG. 4, the label selector 17 includes a first selector 171, a second selector 172, and an integration unit 173.

The first selector 171 performs a first selection of selecting the pseudo label for learning based on the reliability from among the plurality of pseudo labels generated by the student model 11 using the unlabeled data. Specifically, in the first selection, the first selector 171 divides the plurality of pseudo labels into a high-reliability group having high reliability and a low-reliability group having low reliability. Classification of the reliability of the pseudo label may be performed using a known clustering method. The classification of the reliability of the pseudo label may be executed using, for example, a Gaussian mixture model (GMM) or a k-means method. In the following description, it is assumed that the GMM is used as the classification of the reliability.

In the present embodiment, the classification of the reliability using the GMM is performed based on a score of the pseudo label. The score represents the probability at which a portion surrounded by a bounding box (rectangular box) includes an object, and is obtained as the inference result of the student model 11. The score is a number between “0” and “1”. The closer the score is to 0, the more a content of the bounding box is “background”, and the closer the score is to 1, the more the content of the bounding box is “object”.

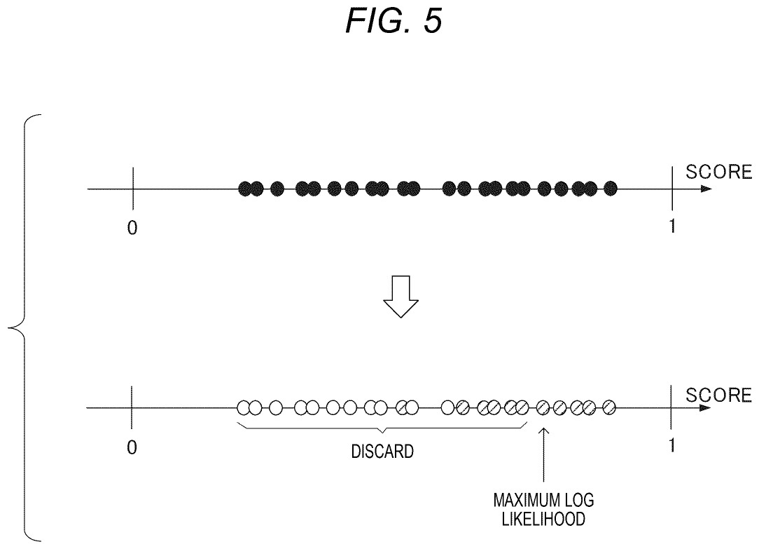

FIG. 5 is a diagram illustrating an outline of the first selection to be executed by the first selector 171. A one-dimensional scatter plot illustrated on an upper side of FIG. 5 illustrates a distribution of scores of the plurality of pseudo labels obtained by processing the unlabeled data included in the mini-batch 3 by the student model 11. The one-dimensional scatter plot illustrated on a lower side of FIG. 5 illustrates a result of executing clustering by the GMM using the score distribution illustrated on the upper side. In the one-dimensional scatter plot illustrated on the lower side of FIG. 5, a cross-hatched circle indicates a pseudo label belonging to the high-reliability group, and an open circle indicates a pseudo label belonging to the low-reliability group.

In the first selection, the first selector 171 selects the pseudo label for learning from the high-reliability group. That is, by the first selection, a pseudo label having high reliability can be kept as the pseudo label for learning. Specifically, the first selector 171 selects, using statistical processing, some of the pseudo labels in the high-reliability group as the pseudo label for learning. All of the pseudo labels belonging to the high-reliability group may be selected as the pseudo label for learning, but by leaving only some of the pseudo labels belonging to the high-reliability group as the pseudo label for learning in this manner, it is possible to perform learning using pseudo labels having higher reliability.

Various methods may be used as a method of determining, by statistical processing, some of the pseudo labels to be kept as the pseudo label for learning from the high-reliability group. In the example illustrated in FIG. 5, among the pseudo labels of the high-reliability group, a score having a maximum log likelihood is determined as a threshold, and a pseudo label having a score equal to or greater than the threshold is kept (selected) as the pseudo label for learning. However, without being limited to such a method, for example, among the pseudo labels of the high-reliability group, a pseudo label having a score equal to or greater than a median value or an average value of the group may be kept as the pseudo label for learning. For example, in a Gaussian distribution (normal distribution) in which the log likelihood in the high-reliability group is maximized, a pseudo label having a score within ±3σ (σ: standard deviation) with respect to the average value of the scores may be kept as the pseudo label for learning.

The second selector 172 performs a second selection of selecting the pseudo label for learning from the pseudo labels based on the image sizes of the objects to which the pseudo labels are given, the pseudo labels being discard targets without being selected as the pseudo label for learning in the first selection by the first selector 171. The image size of the object may be determined according to, for example, a size of the bounding box, and as an example, the image size of the object may be obtained from an area of the bounding box.

In the mini-batch 3, the image size of the object to which the pseudo label is given includes various sizes. An object having a small image size tends to have a lower score of the pseudo label than an object having a large image size due to a small number of assigned anchors or the like. Therefore, there is a tendency that a pseudo label of an object having a large image size whose score tends to be relatively high is determined to have high reliability, and a pseudo label of an object having a small image size whose score tends to be relatively low is determined to have low reliability. That is, in a configuration in which only the first selection based on the reliability described above is performed, a pseudo label of a large object image is likely to be kept as the pseudo label for learning, the image size of the object used for learning is unbalanced, and the detection accuracy of a small object image may decrease. In this regard, in the present embodiment, since the second selection of selecting the pseudo label for learning based on the image size of the object is performed, it is possible to reduce the possibility of occurrence of an imbalance in the image size of the object to be used for learning.

Specifically, in the second selection, the second selector 172 extracts some of the pseudo labels from the pseudo labels as the discard target in the first selection based on the image size of the object. More specifically, in the extraction of the pseudo labels, the second selector 172 extracts some of the pseudo labels in ascending order of the image size of the object. Accordingly, a pseudo label of an object having a small image size can be kept as the pseudo label for learning. For example, top N % of the pseudo labels in ascending order of size are extracted from the pseudo labels as the discard target in the first selection. Here, the smaller the size of the object, the higher the position of the object. A numerical value N in the top N % may be appropriately determined by an experiment or the like, and may be, for example, N %=50%.

In the second selection, the second selector 172 selects the pseudo label for learning based on the reliability from the pseudo labels extracted in ascending order of the image size. Accordingly, when a pseudo label of an object having a small image size is kept as the pseudo label for learning, a pseudo label having relatively high reliability can be kept, and learning can be appropriately performed.

The selection method of the pseudo label for learning based on the reliability in the second selection may be the same as the selection method of the pseudo label for learning based on the reliability in the first selection. Accordingly, it is possible to prevent the selection processing of the pseudo label for learning from being complicated. Specifically, the second selector 172 groups the pseudo labels extracted because the image size of the object is small into a high-reliability group and a low-reliability group based on the score. Then, the second selector 172 selects, using statistical processing, some of the pseudo labels from the high-reliability group as the pseudo label for learning.

In the case of the second selection, the grouping based on the score may also be executed using the GMM as in the case of the first selection. As a method of determining, by statistical processing, some of the pseudo labels to be kept as the pseudo label for learning from the high-reliability group, a method of setting a score having the maximum log likelihood as a threshold may be adopted, similarly to the case of the first selection.

The integration unit 173 integrates a selection result in the first selector 171 and a selection result in the second selector 172. Specifically, both the pseudo label selected as the pseudo label for learning by the first selector 171 and the pseudo label selected as the pseudo label for learning by the second selector 172 are confirmed as final pseudo labels for learning. After the confirmation, the confirmed pseudo label for learning is used for learning, and the pseudo label that is not set as the pseudo label for learning is discarded. Here, the pseudo label as the discard target is excluded from the learning target together with image data corresponding to the pseudo label.

The unsupervised loss calculator 18 (see FIG. 2) calculates an unsupervised loss Lu. The unsupervised loss Lu is the same as the consistency loss described above. The unsupervised loss (consistency loss) Lu is a loss (error) between an inference result obtained by inputting unlabeled data (specifically, data subjected to strong data augmentation) to the teacher model 12 and a pseudo label for learning obtained using the student model 11. The unsupervised loss Lu is calculated by comparing labels (inference results) of the teacher model 12 and the student model 11 for the same original image. Therefore, among labels obtained as the inference result of the teacher model 12, a label corresponding to the pseudo label discarded without being adopted as the pseudo label for learning in the student model 11 is discarded as in the case of the student model 11 and is not set as the learning target.

The unsupervised loss Lu may be obtained by a known method, and may be obtained by, for example, a mean square error or KL divergence. The smaller a value of the unsupervised loss Lu, the more robust the student model 11 is against perturbation. By learning such that the student model 11 is robust against perturbation, it is possible to obtain more abstract invariance for similar input data.

The update unit 19 updates the parameter of the student model 11 based on the unsupervised loss Lu and the supervised loss Ls. Specifically, the update unit 19 obtains a weighted sum (Ls+λuLu; λu is a weight coefficient) of the supervised loss Ls and the unsupervised loss Ls. Then, the parameter (weight) of the student model 11 is updated using backpropagation so that the obtained weighted sum (total loss) is minimized. The parameter of the teacher model 12 is also updated in accordance with the update of the parameter of the student model 11.

As can be seen from the above, in the learning device 100, the processing differs depending on presence or absence of the label of the input data. In the case of labeled data, an inference by the student model 11 is performed, and the supervised loss Ls is obtained using the inference result (see two-dot chain in FIG. 2). In the case of unlabeled data, different processing is performed on the unlabeled data to generate first unlabeled data and second unlabeled data. In the example illustrated in FIG. 2, the first unlabeled data is data subjected to weak data augmentation. When the first unlabeled data is input to the student model 11, a pseudo label for learning is generated (see one-dot chain in FIG. 2). The second unlabeled data is data subjected to strong data augmentation. The inference result obtained by inputting the second unlabeled data to the teacher model 12 is used to calculate the unsupervised loss Lu which is a loss for the pseudo label for learning (see solid arrow in FIG. 2).

In the above description, the selection of the pseudo label for learning for the plurality of images is collectively performed, but this is an example. For example, the selection of the pseudo label for learning may be performed for each image in order. In this case, a threshold that enables selection of whether to adopt the obtained pseudo label as the pseudo label for learning may be set in advance for each image. Such a threshold may be calculated based on statistical processing or rule of thumb, for example.

### 2. LEARNING METHOD

Next, a learning method for performing learning of a machine learning model (student model 11) using unlabeled data, which is executed by the learning device 100, will be described.

### 2-1. Overall Flow of Learning Method

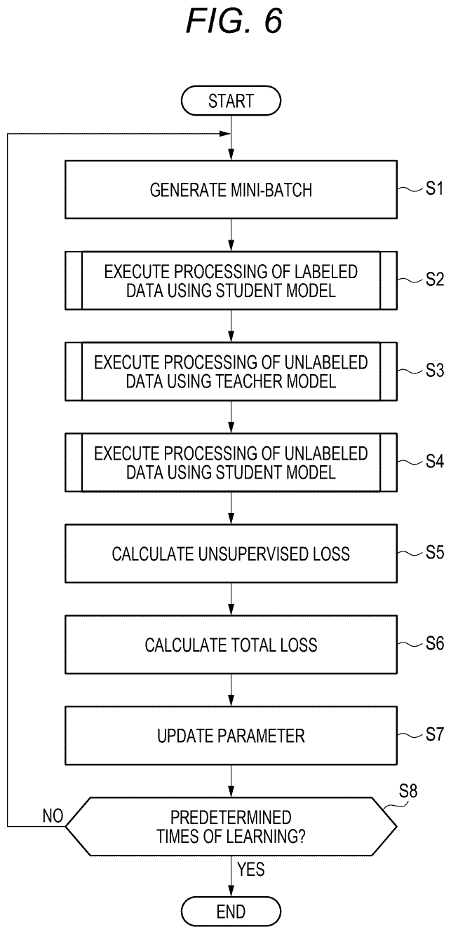

FIG. 6 is a flowchart illustrating a flow of the learning method to be executed by the learning device 100 (controller 1) according to the embodiment of the present invention. The learning method (learning flow) illustrated in FIG. 6 is implemented by the controller 1 (specifically, processor) executing arithmetic processing according to the learning program stored in the memory 2. The learning method illustrated in FIG. 6 is started when preparation of learning data is completed. The learning data includes labeled data and unlabeled data. The learning data may be already stored in the memory 2 of the learning device 100 or may be obtained from the outside.

In step S1, the mini-batch generation unit 13 generates the mini-batch 3 (see FIG. 3) in which labeled data and unlabeled data are mixed. The processing proceeds to the next step S2 in response to generation of the mini-batch 3 being completed.

In step S2, processing using the student model 11 is executed on the labeled data included in the mini-batch 3. Details of the processing of step S2 will be described later. There are a plurality of pieces of labeled data included in the mini-batch 3, and processing using the student model 11 is executed on all of the plurality of pieces of labeled data. The processing proceeds to step S3 in response to the processing of step S2 by the student model 11 being completed.

In step S3, processing using the teacher model 12 is executed on the unlabeled data included in the mini-batch 3. Details of the processing of step S3 will be described later. There are a plurality of pieces of unlabeled data included in the mini-batch 3, and processing using the teacher model 12 is executed on all of the plurality of pieces of unlabeled data. The number of pieces of unlabeled data may be the same as or different from the number of pieces of labeled data. The processing proceeds to step S4 in response to the processing of step S3 being completed.

In step S4, processing using the student model 11 is executed on the unlabeled data included in the mini-batch 3. Details of the processing of step S4 will be described later. As described above, there are a plurality of pieces of unlabeled data included in the mini-batch 3, and processing using the student model 11 is executed on all of the plurality of pieces of unlabeled data. The processing proceeds to step S5 in response to the processing of step S4 being completed.

The order of step S2, step S3, and step S4 is not limited to the order of the present embodiment, and the order may be freely changed. In some cases, while determining whether data extracted from the mini-batch 3 is the labeled data or the unlabeled data, either or both of the processing by the student model 11 and the processing by the teacher model 12 may be repeatedly executed on one piece of data by the number of pieces of data included in the mini-batch 3 as necessary.

In step S5, the unsupervised loss calculator 18 calculates the unsupervised loss Lu. The unsupervised loss Lu is calculated using an inference result of the teacher model 12 obtained in step S3 and a pseudo label for learning obtained in step S4. The processing proceeds to step S6 in response to the unsupervised loss Lu being calculated.

In step S6, the update unit 19 calculates a total loss. Specifically, the total loss is a weighted sum of the supervised loss Ls obtained in step S2 and the unsupervised loss Lu obtained in step S5. The processing proceeds to the next step S7 in response to the total loss being obtained.

In step S7, the update unit 19 updates a parameter of the student model 11 using backpropagation so that the total loss is minimized. The parameter of the teacher model 12 is also updated using an exponential moving average with respect to the updated parameter of the student model 11. The processing proceeds to the next step S8 in response to the parameter update processing being completed.

In step S8, it is determined whether the mini-batch generation unit 13 reaches a predetermined number of times of learning (number of times of generation of mini-batch is predetermined number of times). The predetermined number of times of learning is appropriately determined according to the amount of prepared learning data. When the number of times of learning reaches the predetermined number of times of learning (Yes in step S8), the learning processing illustrated in FIG. 6 is ended. When the number of times of learning does not reach the predetermined number of times of learning (No in step S8), the processing returns to step S1, and the processing in step S1 and subsequent steps is executed. The learning may be completed by repeating the processing illustrated in FIG. 6 for a predetermined number of times (epoch number).

The teacher model 12 for which learning is completed is applied as a learned object detection model (AI model) to, for example, the in-vehicle periphery monitoring device described above. The learned AI model is loaded into the in-vehicle device by, for example, reading from a recording medium or downloading from a server device. In the present embodiment, the teacher model 12 is used as a learned object detection model, but the student model 11 may be used as a learned object detection model.

### 2-2. Processing of Labeled Data

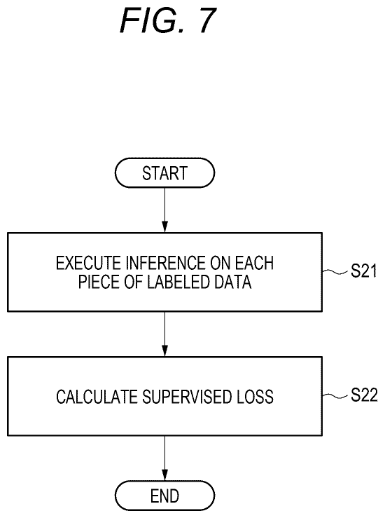

FIG. 7 is a flowchart illustrating detailed processing of step S2 in FIG. 6. That is, FIG. 7 is a flowchart illustrating details of the processing using the student model 11 for the labeled data.

In step S21, the student model 11 executes an inference on the plurality of pieces of labeled data included in the mini-batch 3 in order. The processing proceeds to the next step S22 in response to the inference by the student model 11 being executed for all pieces of labeled data included in the mini-batch 3. The labeled data input to the student model 11 may be subjected to data augmentation and input to the student model 11. In addition, one piece of labeled data may be extended to a plurality of pieces of labeled data by using data augmentation.

In step S22, the supervised loss calculator 16 calculates the supervised loss Ls using all inference results obtained in step S21 and labels of all the labeled data. The obtained supervised loss Ls is stored in the memory 2. Accordingly, the processing using the student model 11 for the labeled data (processing of step S2) is completed.

### 2-3. Processing Using Teacher Model for Unlabeled Data

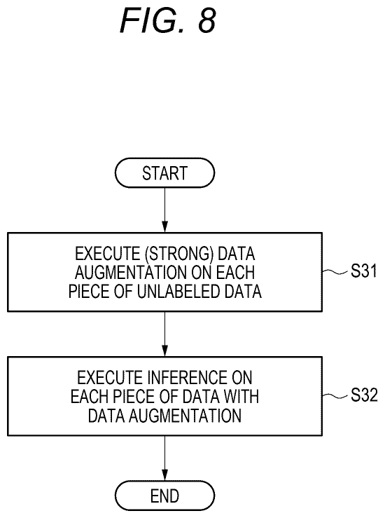

FIG. 8 is a flowchart illustrating detailed processing of step S3 in FIG. 6. That is, FIG. 8 is a flowchart illustrating details of the processing using the teacher model 12 for the unlabeled data.

In step S31, the second data augmentation unit 15 performs strong data augmentation in order on the plurality of pieces of unlabeled data included in the mini-batch 3. The processing proceeds to the next step S32 in response to data augmentation processing by the second data augmentation unit 15 being executed on all unlabeled data included in the mini-batch 3.

In step S32, the teacher model 12 executes an inference in order on all the unlabeled data subjected to strong data augmentation (second unlabeled data). A result obtained by the inference (inference result) is stored in the memory 2. The processing using the teacher model 12 for the unlabeled data (processing of step S3) is completed in response to the inference by the teacher model 12 being executed for all the unlabeled data subjected to the strong data augmentation.

### 2-4. Processing Using Student Model for Unlabeled Data

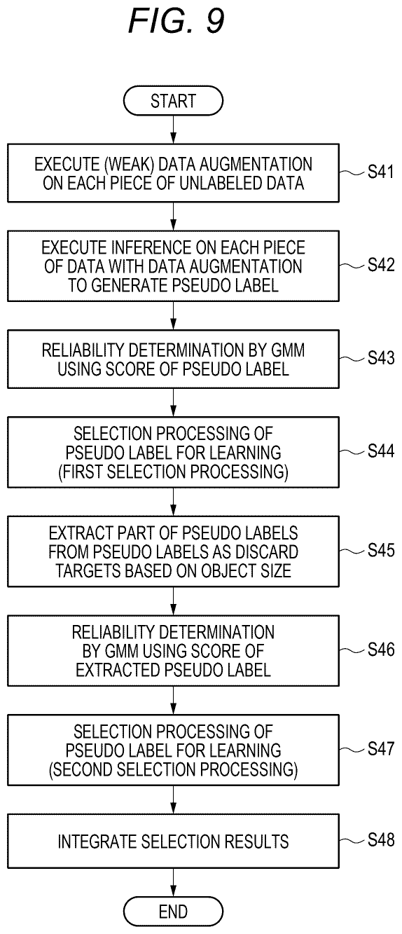

FIG. 9 is a flowchart illustrating detailed processing of step S4 in FIG. 6. That is, FIG. 9 is a flowchart illustrating details of the processing using the student model 11 for the unlabeled data.

In step S41, the first data augmentation unit 14 performs weak data augmentation on the plurality of pieces of unlabeled data included in the mini-batch 3 in order. The processing proceeds to the next step S42 in response to the data augmentation processing by the first data augmentation unit 14 being executed on all the unlabeled data included in the mini-batch 3.

In step S42, the student model 11 executes an inference in order on all unlabeled data subjected to weak data augmentation (first unlabeled data). As a result of the inference, pseudo labels are generated. The generated pseudo labels are stored in the memory 2. The processing proceeds to the next step S43 in response to the inference by the student model 11 being executed for all the unlabeled data subjected to weak data augmentation.

In step S43, the label selector 17 (specifically, first selector 171) performs reliability determination by the GMM using each score of all the generated pseudo labels. By the reliability determination, the generated pseudo labels are divided into a high-reliability group and a low-reliability group as described above. The processing proceeds to the next step S44 in response to grouping based on the reliability determination being completed.

In step S44, the label selector 17 (specifically, first selector 171) performs selection processing (first selection processing) of a pseudo label for learning using a result of the reliability determination in step S43. In the first selection processing, a pseudo label having high reliability is selected as the pseudo label for learning from all the generated pseudo labels. Specifically, in the first selection processing, some of the pseudo labels belonging to the high-reliability group are selected as the pseudo label for learning. For example, among the pseudo labels belonging to the high-reliability group, a pseudo label having a score equal to or greater than a threshold is selected as the pseudo label for learning, the threshold being a score having the maximum log likelihood. The pseudo label left without being selected as the pseudo label for learning by the first selection processing is temporarily set as a discard target. The discard target means a target not being used for learning. The processing proceeds to the next step S45 in response to the first selection processing being completed.

In step S45, the label selector 17 (specifically, second selector 172) extracts some of the pseudo labels from the pseudo labels as the discard target in the first selection processing based on image sizes of objects to which the pseudo labels are given. Specifically, top N % (Nis any numerical value) pseudo labels for which the image size of the object is small are extracted. The image size of the object may be determined according to the size of the bounding box, and for example, the area of the bounding box may be used. The processing proceeds to the next step S46 in response to the extraction of the pseudo label with small object image being completed.

In step S46, the label selector 17 (specifically, second selector 172) performs the reliability determination by the GMM using the score of the pseudo label, as in step S43, for the plurality of pseudo labels extracted based on the image size of the object. By the reliability determination, the plurality of pseudo labels extracted based on the image size of the object are divided into a high-reliability group and a low-reliability group. The processing proceeds to the next step S47 in response to the grouping based on the reliability determination being completed.

In step S47, the label selector 17 (specifically, second selector 172) performs selection processing of a pseudo label for learning (second selection processing) using the result of the reliability determination in step S46. In the second selection processing, a pseudo label having high reliability is selected as the pseudo label for learning from the pseudo labels extracted based on the image size of the object (pseudo labels with small object images). Specifically, in the second selection processing, some of the pseudo labels belonging to the high-reliability group are selected as the pseudo label for learning by the same method as in the first selection processing. The processing proceeds to the next step S48 in response to the selection of the pseudo label for learning by the second selection processing being completed.

In step S48, the label selector 17 (specifically, integration unit 173) integrates selection results of the first selection processing and the second selection processing. Specifically, the pseudo label for learning selected in each of the first selection processing and the second selection processing is confirmed as the pseudo label to be used for learning. Among all the pseudo labels obtained as the inference result of the student model 11, a pseudo label that is not selected as the pseudo label for learning in the first selection processing and the second selection processing is confirmed as the discard target. By confirming the pseudo label for learning and the pseudo label as the discard target, the processing using the student model 11 for the unlabeled data (processing of step S4) is completed.

As can be seen from the above description, with the learning method according to the present embodiment, a pseudo label with a small object size (image size) which is likely to be set as the discard target in the first selection processing based on only the reliability is likely to be added to the learning target by the second selection processing that is additionally performed. Therefore, it can be expected that learning with most of objects having large image sizes is less likely to occur and learning of an object having a small image size is appropriately performed. As a result, it is possible to generate an object detection model capable of appropriately performing object detection regardless of the image size of the detection target.

### 3. MODIFICATIONS

### 3-1. First Modification

The present invention may select a pseudo label for learning from a plurality of pseudo labels generated by a machine learning model (student model 11) based on the reliability of the pseudo labels and image sizes of objects to which the pseudo labels are given. In the first modification, the plurality of pseudo labels are classified into a plurality of groups based on the image size of the object, and the pseudo label for learning is selected for each of the plurality of groups based on the reliability of the pseudo label.

In the configuration of the present modification, selection of a pseudo label to be used for learning can also be performed in consideration of not only the reliability of the pseudo label but also the image size of the object to which the pseudo label is given, similarly to the above-described embodiment. That is, it is possible to make it less likely that many or most of discarded pseudo labels are pseudo labels of small object images at the time of selecting pseudo labels. As a result, it is possible to generate an object detection model (AI model) capable of accurately detecting an object regardless of the image size of the object.

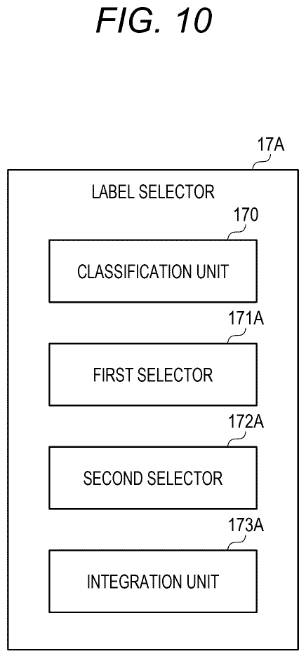

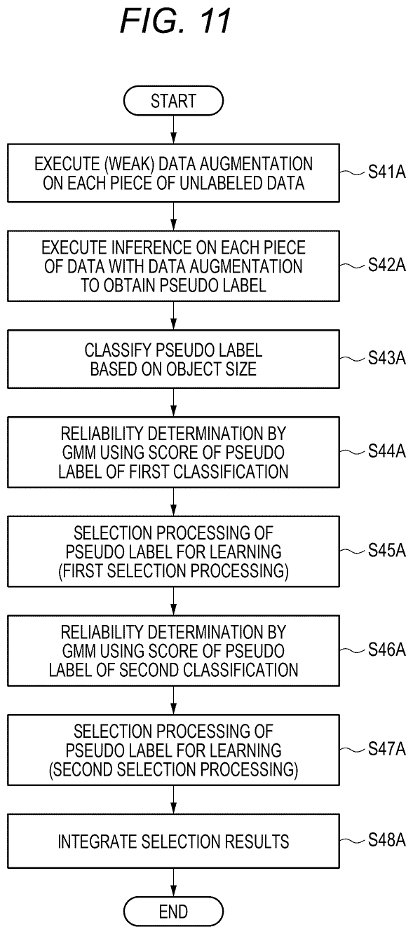

FIG. 10 is a block diagram illustrating a detailed functional configuration of a label selector 17A according to the first modification. FIG. 11 is a flowchart illustrating processing using the student model 11 of unlabeled data in the learning device 100 according to the first modification. The flowchart illustrated in FIG. 11 corresponds to a modification of the flowchart illustrated in FIG. 9 described above.

As illustrated in FIG. 10, the label selector 17A includes a classification unit 170, a first selector 171A, a second selector 172A, and an integration unit 173A. Functions of these units will be described together with the description of the flowchart illustrated in FIG. 11.

Processing of step S41A and step S42A are the same as the processing of step S41 and step S42 described above. Therefore, the description of the processing will be omitted.

In step S43A, the classification unit 170 classifies a plurality of pseudo labels generated by the student model 11 into a plurality of groups based on an image size of an object. The image size of the object is given by, for example, an area of a bounding box. Specifically, the plurality of groups are a large-object group in which the image size of the object is large and a small-object group in which the image size of the object is small. The classification unit 170 classifies, with reference to a preset threshold for the image size of the object, a pseudo label of an object having an image size equal to or larger than the threshold into the large-object group, and a pseudo label of an object having an image size smaller than the threshold into the small-object group. The processing proceeds to the next step S44A in response to classification based on the image size of the object being completed.

In the present modification, the number of groups classified by the image size of the object is two. The number of groups classified by the image size of the object may be three or more. When the number of groups is two as in the present modification, a pseudo label of an object having a small image size can be easily kept as the pseudo label for learning while mitigating an increase in processing load. In the following description, one of the large-object group and the small-object group classified by the classification unit 170 is referred to as a first classification, and the other is referred to as a second classification.

In step S44A, the first selector 171A performs reliability determination by GMM using each score of the pseudo labels of the first classification. By the reliability determination, the pseudo labels of the first classification are divided into a high-reliability group and a low-reliability group. The processing proceeds to the next step S45A in response to the grouping of the first classification by the reliability determination being completed.

In step S45A, the first selector 171A performs selection processing of a pseudo label for learning (first selection processing) using a result of the reliability determination in step S44A. In the first selection processing, a pseudo label having high reliability is selected as the pseudo label for learning from the pseudo labels of the first classification. Specifically, in the first selection processing, some of the pseudo labels belonging to the high-reliability group are selected as the pseudo label for learning. The selection method may be, for example, a method in which a score having the maximum log likelihood is set as a threshold, as in the above-described embodiment. The processing proceeds to the next step S46A in response to the first selection processing being completed.

In step S46A, the second selector 172A performs reliability determination by GMM using each score of the pseudo labels of the second classification. By the reliability determination, the pseudo labels of the second classification are divided into a high-reliability group and a low-reliability group. The processing proceeds to the next step S47A in response to the grouping of the second classification by the reliability determination being completed.

In step S47A, the second selector 172A performs selection processing of a pseudo label for learning (second selection processing) using a result of the reliability determination in step S46A. In the second selection processing, a pseudo label having high reliability is selected as the pseudo label for learning from the pseudo labels of the second classification. Specifically, in the second selection processing, some of the pseudo labels belonging to the high-reliability group are selected as the pseudo label for learning. As in the case of the first selection processing in step S45A, the selection method may be, for example, a method in which a score having the maximum log likelihood is used as a threshold. The processing proceeds to the next step S48A in response to the second selection processing being completed.

In step S48A, the integration unit 173A integrates selection results of the first selection processing and the second selection processing. Specifically, the pseudo label for learning selected in each of the first selection processing and the second selection processing is confirmed as the pseudo label to be used for learning. Among all the pseudo labels obtained as the inference result of the student model 11, a pseudo label that is not selected as the pseudo label for learning in the first selection processing and the second selection processing is confirmed as the discard target. By confirming the pseudo label for learning and the pseudo label as the discard target, the processing using the student model 11 for the unlabeled data is completed.

As can be seen from the above description, in the present modification, processing is performed in which in each of the large-object group and the small-object group, a plurality of pseudo labels in the group are divided into a high-reliability group having high reliability and a low-reliability group having low reliability based on the reliability, and a pseudo label for learning is selected from the high-reliability group.

Accordingly, regarding pseudo labels with large object image and pseudo labels with small object image, a pseudo label having high reliability can be selected as the pseudo label for learning. As a result, it is possible to make learning that is partial in terms of the image size of the object less likely to occur, and it is possible to generate an object detection model capable of appropriately performing object detection regardless of the image size of the target object.

### 3-2. Second Modification

Although the characteristic configuration of the present invention is used in a part of semi-unsupervised learning in the above description, the characteristic configuration of the present invention may be used as a generation method of learning data. A second modification discloses a method of generating labeled data with labels from unlabeled data with no labels using a machine learning model.

In the learning data generation method according to the second modification, a plurality of pieces of unlabeled data are input to the machine learning model to generate a plurality of pseudo labels. Next, some pseudo labels are selected from the plurality of pseudo labels based on the reliability of the pseudo labels and image sizes of objects to which the pseudo labels are given. Next, labeled data using the selected some pseudo labels as labels is generated. Hereinafter, a specific example will be described.

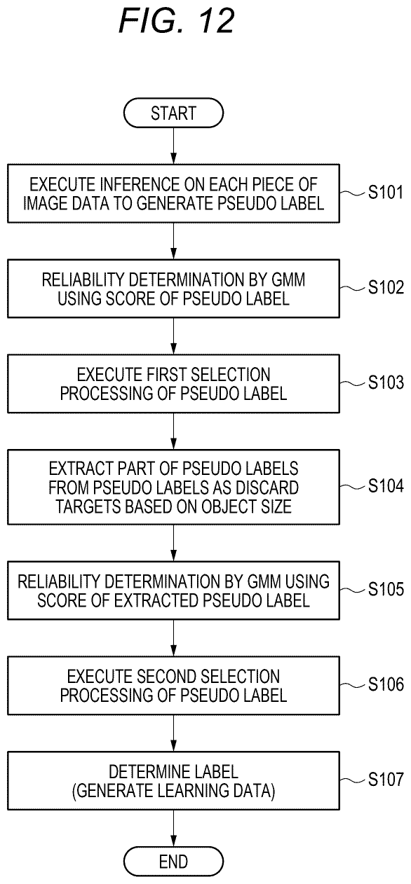

FIG. 12 is a flowchart illustrating a flow of the learning data generation method according to the second modification. The learning data generation method illustrated in FIG. 12 is implemented by a controller (specifically, processor included in controller) included in a learning data generation device (not illustrated) executing arithmetic processing according to a learning data generation program stored in a memory. The learning data generation method illustrated in FIG. 12 is started when preparation of a plurality of pieces of image data with no labels (learning data candidate image as labeled data) is completed. The learning data candidate image may be already stored in the memory of the learning data generation device or may be configured to be obtained from the outside.

In step S101, the machine learning model executes an inference on all learning data candidate images in order. The machine learning model is an object detection model and is a learned model. Pseudo labels are generated as a result of the inference of the machine learning model. The generated pseudo labels are stored in the memory. The processing proceeds to the next step S102 in response to the inference by the machine learning model being executed for all the learning data candidate images.

In step S102, reliability determination by GMM is performed using each score of all the generated pseudo labels. By the reliability determination, the generated pseudo labels are divided into a high-reliability group and a low-reliability group. The processing proceeds to the next step S103 in response to the grouping based on the reliability determination being completed.

In step S103, first selection processing of a pseudo label is performed using a result of the reliability determination in step S102. In the first selection processing, some pseudo labels belonging to the high-reliability group are selected from all the generated pseudo labels. For example, among the pseudo labels belonging to the high-reliability group, a pseudo label having a score equal to or greater than a threshold is selected as the pseudo label for learning, the threshold being a score having the maximum log likelihood. The pseudo label left without being selected by the first selection processing is temporarily set as a discard target. The processing proceeds to the next step S104 in response to the first selection processing being completed.

In step S104, some pseudo labels are extracted from the pseudo labels as the discard target in the first selection processing based on image sizes of objects to which the pseudo labels are given. Specifically, top N % (N is any numerical value) pseudo labels for which the image size of the object is small are extracted. The image size of the object may be determined according to a size of a bounding box, and for example, may be determined according to an area of the bounding box. The processing proceeds to the next step S105 in response to extraction of a pseudo label of a small object image being completed.

In step S105, the reliability determination by the GMM is performed using the score of the pseudo label, as in step S102, for the plurality of pseudo labels extracted based on the image size of the object. By the reliability determination, the plurality of pseudo labels extracted based on the image size of the object are divided into a high-reliability group and a low-reliability group. The processing proceeds to the next step S106 in response to the grouping based on the reliability determination being completed.

In step S106, second selection processing of a pseudo label is performed using a result of the reliability determination in step S105. In the second selection processing, some pseudo labels belonging to the high-reliability group are selected from the pseudo labels (pseudo labels of small object image) extracted based on the image size of the object. The selection method may be, for example, a method in which a score having the maximum log likelihood is set as a threshold, as in step S103. The processing proceeds to the next step S107 in response to the second selection processing being completed.

In step S107, a label to be used for learning is determined. That is, learning data is generated. Specifically, the pseudo label selected in each of the first selection processing and the second selection processing is determined as the labels. Image data to which the determined labels are attached is determined as the labeled data. Pseudo labels that are not selected in the first selection processing and the second selection processing are discarded and are not used as the labels.

The image data confirmed as the labeled data is stored in the memory as learning data. The labeled data generated in this manner is appropriately used as learning data in a learning device that performs learning of a machine learning model.

As can be seen from the above description, with the learning data generation method according to the present modification, a pseudo label of an object having a small image size which is likely to be set as the discard target in the first selection processing based on only the reliability is likely to be added to the labels by the second selection processing that is additionally performed. Therefore, it can be expected that by using the labeled data generated by the learning data generation method, learning with most of objects having large image sizes is less likely to occur and learning with objects having small image sizes is appropriately performed.

### 4. NOTES AND THE LIKE

Various technical features disclosed in the embodiments for carrying out the invention in the present description may be variously modified without departing from the gist of the technical creation. For example, at least a part of the configuration implemented by software described above may be implemented by hardware. In addition, a plurality of embodiments and modifications disclosed in the embodiments for carrying out the invention of the present description may be combined and implemented within a possible range.

### 5. APPENDIX

(1) A learning method for performing learning of a machine learning model using unlabeled data with no labels, the learning method including:
inputting the unlabeled data to the machine learning model to generate pseudo labels;
performing a first selection of selecting a pseudo label for learning from the generated pseudo labels based on reliability;
performing a second selection of selecting, based on image sizes of objects to which the pseudo labels are given, the pseudo label for learning from pseudo labels that are discard targets that has not been selected as the pseudo label for learning in the first selection; and
performing the learning using the pseudo label for learning.
(2) A learning method for performing learning of a machine learning model using unlabeled data with no labels, the learning method including:
inputting the unlabeled data to the machine learning model to generate pseudo labels;
classifying a plurality of the pseudo labels into a plurality of groups based on image sizes of objects;
performing, for each of the plurality of groups, selection of the pseudo label for learning based on reliability of pseudo labels included in the group; and
performing the learning using the pseudo label for learning.
(3) A learning data generation method, which is a method for generating supervised image data with labels from unsupervised image data with no labels using a machine learning model, the method including:
inputting a plurality of pieces of the unsupervised image data to the machine learning model to generate a plurality of pseudo labels;
performing a first selection of selecting a pseudo label for learning from the generated pseudo labels based on reliability;
performing a second selection of selecting, based on image sizes of objects to which the pseudo labels are given, the pseudo label for learning from pseudo labels that are discard targets that has not been selected as the pseudo label for learning in the first selection; and
generating the supervised image data in which the selected one or more pseudo labels are set as the labels.
(4) A learning data generation method, which is a method for generating supervised image data with labels from unsupervised image data with no labels using a machine learning model, the method including:
inputting a plurality of pieces of the unsupervised image data to the machine learning model to generate a plurality of pseudo labels;
performing a first selection of selecting a pseudo label for learning from the generated pseudo labels based on reliability;
performing a second selection of selecting, based on image sizes of objects to which the pseudo labels are given, the pseudo label for learning from pseudo labels that are discard targets that has not been selected as the pseudo label for learning in the first selection; and
generating the supervised image data in which the selected one or more pseudo labels are set as the labels.
(5) A monitoring device mounted on a vehicle, wherein the monitoring device is configured to detect objects in a periphery of the vehicle using the machine learning model according to (1).
(6) A monitoring device mounted on a vehicle, wherein the monitoring device is configured to detect objects in a periphery of the vehicle using the machine learning model according to (2).

1. A learning method for performing learning of a machine learning model using unlabeled data with no labels, the learning method comprising:
inputting the unlabeled data to the machine learning model to generate pseudo labels;
performing a first selection of selecting a pseudo label for learning from the generated pseudo labels based on reliability;
performing a second selection of selecting, based on image sizes of objects to which the pseudo labels are given, the pseudo label for learning from pseudo labels that are discard targets that has not been selected as the pseudo label for learning in the first selection; and
performing the learning using the pseudo label for learning.

2. The learning method according to claim 1, wherein
the first selection comprises:
dividing the pseudo labels into a high-reliability group having high reliability and a low-reliability group having low reliability; and
selecting the pseudo label for learning from the high-reliability group.

3. The learning method according to claim 2, wherein
one or more pseudo labels in the high-reliability group are selected, using statistical processing, as the pseudo label for learning.

4. The learning method according to claim 1, wherein
second selection comprises;
extracting one or more pseudo labels from the pseudo labels that are the discard target based on the image sizes of the objects; and
selecting the pseudo label for learning from the extracted pseudo label based on the reliability.

5. The learning method according to claim 4, wherein
in the extraction of the one or more pseudo labels, the one or more pseudo labels are extracted in ascending order of the image sizes of the objects.

6. The learning method according to claim 4, wherein
a selection method of the pseudo label for learning based on the reliability in the second selection is the same as a selection method of the pseudo label for learning based on the reliability in the first selection.

7. A learning method for performing learning of a machine learning model using unlabeled data with no labels, the learning method comprising:
inputting the unlabeled data to the machine learning model to generate pseudo labels;
classifying a plurality of the pseudo labels into a plurality of groups based on image sizes of objects;
performing, for each of the plurality of groups, selection of the pseudo label for learning based on reliability of pseudo labels included in the group; and
performing the learning using the pseudo label for learning.

8. The learning method according to claim 7, wherein
the plurality of groups are a large-object group in which the image size of the object is larger than a threshold and a small-object group in which the image size of the object is smaller than the threshold.

9. The learning method according to claim 8, wherein
in each of the large-object group and the small-object group,
dividing the pseudo labels in the group into a high-reliability group having high reliability and a low-reliability group having low reliability based on the reliability, and
selecting the pseudo label for learning from the high-reliability group.

10. The learning method according to claim 1, further comprising:
generating first unlabeled data and second unlabeled data by performing different processing on the unlabeled data;
inputting the first unlabeled data to the machine learning model to generate the pseudo label for learning;
obtaining an unsupervised loss that is a loss between the pseudo label for learning and an inference result obtained by inputting the second unlabeled data to another machine learning model different from the machine learning model; and
updating a parameter of the machine learning model based on the unsupervised loss.

11. The learning method according to claim 1, further comprising:
obtaining a supervised loss that is a loss between the label and an inference result obtained by inputting labeled data with the labels to the machine learning model; and
updating the parameter based on the unsupervised loss and the supervised loss.

12. A learning device for performing learning of a machine learning model using unlabeled data with no labels, wherein
the learning device comprises circuitry configured to:
input the unlabeled data to the machine learning model to generate pseudo labels;
perform a first selection of selecting a pseudo label for learning from the generated pseudo labels based on reliability;
perform a second selection of selecting, based on image sizes of objects to which the pseudo labels are given, the pseudo label for learning from pseudo labels that are discard targets that has not been selected as the pseudo label for learning in the first selection; and
perform the learning using the pseudo label for learning.

13. A non-transitory computer-readable storage medium storing a learning program that causes a learning device to execute the learning method according to claim 1.
